(19) United States
(12) Patent Application Publication
(10) Pub. No.: US 2007/0082559 A1
(43) Pub. Date: Apr. 12, 2007

(54) Contact spring

(75) Inventors: Jun Hee Ryu, Gyungsangbook-do (KR); Kap Jin Lee, Gwangju-si (KR)

Correspondence Address: BIRCH STEWART KOLASCH & BIRCH, PO BOX 747, FALLS CHURCH, VA, 22040-0747, US

(73) Assignee: LG INNOTEK CO., LTD., Seoul (KR)

(21) Appl. No.: 10/578,910

(22) PCT Filed: Jun. 28, 2005
(86) PCT No.: PCT/KR05/02020

§ 371 Date: May 12, 2006

(30) Foreign Application Priority Data
Jun. 30, 2004 (KR) 10-2004-0049880

(51) Int. Cl. H01R 13/15

(52) U.S. Cl. 439/839

(57) ABSTRACT

A contact spring comprises: a support portion connected to electrical equipment; a contact portion electrically connected to an external power supply terminal; at least two bent portions connected between the support portion and the contact portion and having a bent shape.

### TECHNICAL FIELD

The present invention relates to a spring structure, and more particularly, to a contact spring structure used as a power supply terminal for electrical equipment.

### BACKGROUND ART

The methods for supplying power to a vibration motor, a kind of reception sensor of a mobile communication terminal as an example of electrical equipment, include lead wire soldering, the direct soldering of a FPCB of a terminal and a FPCB land of a vibrating motor, a supply method using a connector, a supply method using a contact spring attached to a vibration motor.

FIG. 1 is a view schematically showing a bar type vibration motor with a contact spring mounted thereon according to the related art.

As shown in FIG. 1, in the supply method using a contact spring 10, when a vibration motor 20 with a contact spring mounted thereon is secured to a terminal structure, and a terminal PCB designed according to the location of the contact spring 10 is secured to the terminal structure, a PCB land connected to a terminal power source comes into contact with the contact spring 10, whereby the weight 30 of the vibration motor 20 is eccentrically rotated to generate vibration.

To ensure smooth power supply through a contact between the contact spring 10 and the PCB land of the terminal, the contact spring 10 has to maintain a proper level of repulsive force, and has to be designed so that the contact of the contact spring 10 may not deviate from the PCB land of the terminal.

FIG. 2 is a view showing a contact spring structure used for a vibration motor according to the related art.

Referring to (a) through (d) of FIG. 2, the related art contact spring 10 is of an integral type, roughly comprising a contact portion 11 contacting a PCB land connected to an external power source, a support portion 13 directly secured to the vibration motor or contacting the same, and a bent portion 12 connecting between the contact portion 11 and the support portion 13.

The contact portion 11 is basically formed in an arc-shaped curve in order to reduce the amount of change in the position of the contact with the PCB land of the terminal according to the amount of compression of the spring and increase the reliability of a connection between the PCB land and the contact, or may be embossed in the shape of a semispherical or arc-shaped strip.

The support portion 13 is constructed of a horizontal surface, a vertical surface, or a combination of a horizontal surface and a vertical surface, and may be constructed in various shapes according to the type of a vibration motor used or limiting conditions of instruments. Further, a soldering form for electrically connecting a coil end of the motor and the contact spring 10 may be added to the support portion 13, or alternatively they may be electrically connected by soldering or welding.

The bent portion 12 is basically constructed in a shape similar to a ¹C shape or its symmetrical shape, or may be constructed in a complete semispherical shape according to whether fillet treatment is done or not.

In the related art contact spring structure, most parts of the energy stored in the contact spring as the contact spring is compressed are concentrated on the bent portion 12, and the energy is proportional to the square of a strain.

At this time, the intensity of stress generated in the contact spring is proportional to the amount of strain by Hook's Law (stress=Young's modulus×strain). If a stress exceeding the threshold of the spring as represented by a tensile strength is generated, there may occur a phenomenon that the contact spring is permanently deformed.

In case of such a permanent deformation, there is a risk that the size of a repulsive force, generated when the contact between the PCB land of the terminal and the contact spring are compressed, may be reduced lower than a proper level, and thereby a power supply to the vibration motor is not done smoothly.

Moreover, the elastic modulus (k) of the spring is proportional to the thickness (T) of spring material and the surface area (A) of the bent portion, and the energy (E) stored in the bent portion is expressed as a function of the elastic modulus (k) and of the amount of compression (x). Further, the volume (V) of the bent portion is equal to the product of the thickness of spring material and the surface area (A).

In other words, in A:oc T³A, E=4_−k×² V=T·A, the energy (E/V) stored per unit volume of the spring is expressed by

$${V}^{IC} ∝ {2}^{1} {J}^{′} : {x}^{2} .$$

As described above, while the energy density per unit volume represented by a strain-energy density is proportional to the square of a strain and of a spring thickness (T), it is almost not affected by the surface area (A).

To increase the elastic modulus while keeping a constant amount of compression in such a related art contact spring structure, a method of increasing the thickness of the material or increasing the width of the surface area of the bent portion may be employed.

However, the stress generated by an increase of the thickness of the spring material increases in proportion to the thickness (T), thus reducing the durability.

Further, because the contact of the contact portion rotates relative to the bent portion, which is a region where the stress is concentrated, the contact moves in a direction perpendicular to the compression direction and may deviate from the PCB land of the terminal. If the length of the bent portion is increased in order to prevent an increase of the stress, the rotation center of the contact becomes far from the contact to thereby increase the amount of movement of the contact in a direction perpendicular to the compression direction.

### DISCLOSURE

[Technical Problem]

Accordingly, it is an object of the present invention to propose a shape of a contact spring having a high elastic modulus while keeping a constant amount of compression, and provide a contact spring, which can attain durability by alleviating the phenomenon of concentration of a stress distributed over a contact spring, so that the magnitude of the generated stress may not exceed the tensile strength of contact spring material.

Furthermore, it is another object of the present invention to provide a vibration motor with a contact spring, which can attain durability by alleviating the phenomenon of concentration of a stress distributed over a contact spring, so that the magnitude of the generated stress may not exceed the tensile strength of contact spring material.

[Technical Solution]

To achieve one of the objects, there is provided a contact spring according to the present invention, comprising: a support portion connected to electrical equipment; a contact portion electrically connected to an external power supply terminal; and at least two bent portions connected between the support portion and the contact portion and having a bent shape.

To achieve the other object, there is provided a vibration motor according to the present invention, comprising: a contact spring provided with a support portion, a contact portion electrically connected to an external power supply terminal and at least two bent portions connected between the support portion and the contact portion and having a bent shape; and a vibrating portion eccentrically rotating by power supplied from outside through the support portion.

[Advantageous Effects]

According to the present invention, the strain-energy density stored in the bent portions of the contact spring is reduced, and thus the magnitude of the stress distributed over the bent portions is reduced, thereby providing a contact spring having a higher durability.

Furthermore, according to the present invention, the rotation phenomenon of the contact is reduced by adjusting the width of each bent portion and bent portion joint according to the relative location of the contact portion and the bent portion, and thus the amount of change in the relative location of the PCB land of the terminal and the contact can be reduced.

Furthermore, the contact spring is prevented from permanent deformation due to compression by uniformly dispersing the stress distributed over each bent portion by adjusting the width of the bent portion.

### DESCRIPTION OF DRAWINGS

FIG. 1 is a view schematically showing a bar type vibration motor with a contact spring mounted thereon according to the related art.

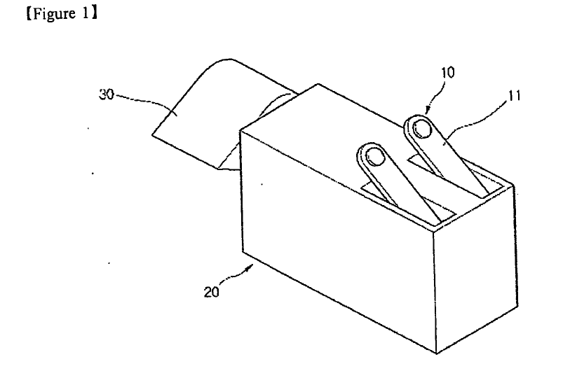

FIG. 2 is a view showing a contact spring structure used for a vibration motor according to the related art.

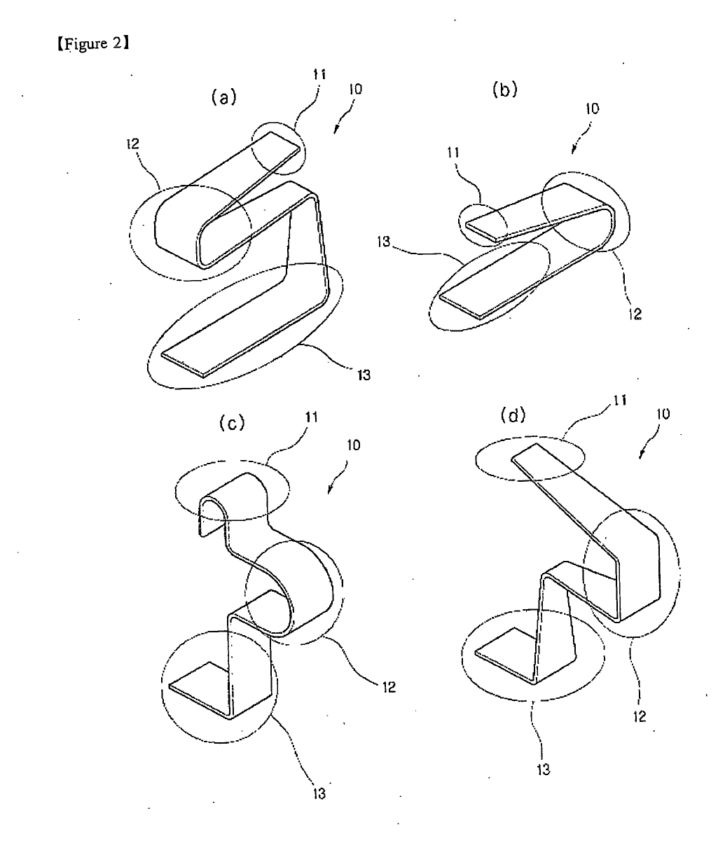

FIG. 3 is a view showing various embodiments of a contact spring according to the present invention.

FIG. 4 is a view showing a coin type vibration motor for which a contact spring is used according to the present invention.

### MODE FOR INVENTION

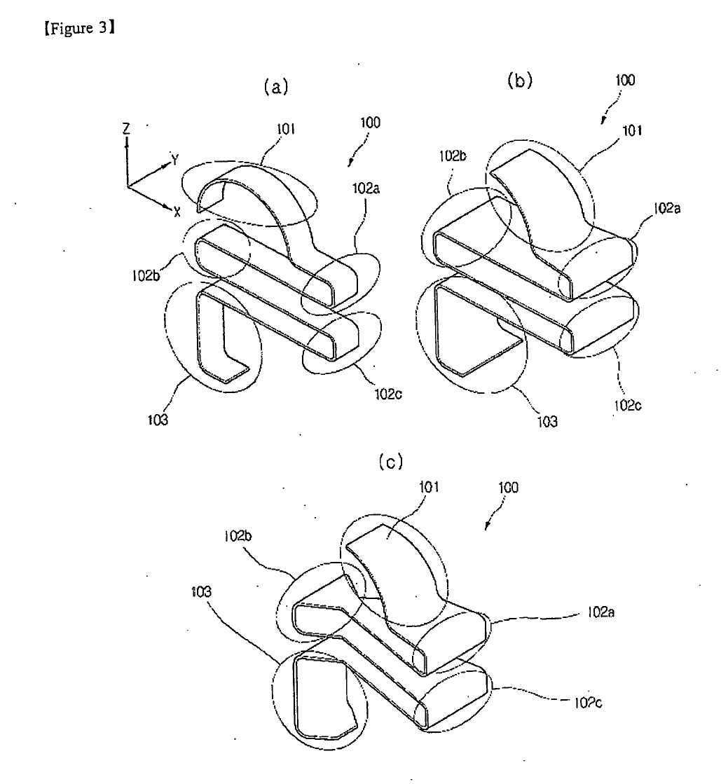

FIG. 3 is a view showing various embodiments of a contact spring according to the present invention.

Referring to (a) through (c) of FIG. 3, the contact spring 100 according to the invention is of an integral type, roughly comprising a contact portion 101 contacting a PCB land connected to an external power source, a support portion 103 directly secured to the vibration motor or contacting the same, and bent portions 102a to 102c connecting between the contact portion 101 and the support portion 103.

More concretely, the contact portion 101 is basically formed in an arc-shaped curve bent with a given curvature in order to reduce the amount of change in the position of the contact with the PCB land of the terminal according to the amount of compression of the contact spring and increase the reliability of a connection between the PCB land and the contact, or may be embossed in the shape of a semispherical or arc-shaped strip.

The support portion 103 is constructed of a horizontal surface, a vertical surface, or a combination of a horizontal surface and a vertical surface, and may be constructed in various shapes according to the type of a vibration motor used or limiting conditions of instruments. Further, a soldering form for electrically connecting a coil end of the motor and the contact spring 100 may be added to the support portion 103, or alternatively they may be electrically connected by soldering or welding.

The contact portion 101 and the support portion 103 are connected to at least two bent portions 102a to 102c. The bent portions 102a to 102c are constructed in a shape similar to a ¹α¹ shape bent approximately perpendicularly or its symmetrical shape. Here, the bent portions 102a to 102c may be constructed in a complete semispherical shape according to whether fillet treatment is done or not.

In the contact spring structure having the above construction according to the present invention, most parts of the energy stored as the contact spring is compressed are stored dispersed in the bent portions 102a to 102c, and the density of the energy stored in the bent portions 102a to 102c can be represented by a strain-energy density.

Here, the strain-energy density stored in the bent portions 102a to 102c is proportional to the square of a strain. At this time, the intensity of stress generated is proportional to the strain of the spring by Hook's Law (stress =Young's modulus×strain).

The energy stored in the contact spring structure according to the present invention is stored dispersed through two or more bent portions 1.02a to 102c. Accordingly, the strain-energy density stored in the respective bent portions 102a to 102c becomes lower, and the intensity of the stress generated is also reduced.

Meanwhile, in order to increase the repulsive force (contact force) or elastic modulus (stiffness) of the spring in a given amount of compression without increasing the intensity of the stress generated in the bent portions 102a to 102c, the energy density of the bent portions 102a to 102c has to be kept constant.

To keep a constant energy density of the bent portions while increasing the repulsive force, it is advantageous to increase the width of the bent portions rather than the width of spring material.

This is because the elastic modulus (k) is k∝‘I’³ A and proportional to the cube of the thickness (T) of the spring material while the energy (E/V) stored per unit
volume of the spring is

$$\frac{E}{V} α \frac{1}{2} {r}^{2} {x}^{2}$$

and proportional to the square of the thickness (T) of the spring material but not related to the surface area (A) of the bent portions.

That is to say, the surface area (A) of the bent portions affects the elastic modulus (k) but does not affect the energy value stored in unit volume of the contact spring, Thus, by increasing the surface area (A), the repulsive force of the contact spring can be increased while keeping the energy density of the bent portions constant. Therefore, the width of the bent portions is increased in order to increase the surface area (A) of the bent portions 102a to 102c.

As described above, the structure of the contact spring that increases the width of the bent portions 102a to 102c is shown in (b) of FIG. 3.

As shown in (b) of FIG. 3, if the width of the bent portions 102a to 102c is increased, the repulsive force or elastic modulus of the contact spring is increased and the density of energy stored per unit volume is kept constant, resultantly keeping the intensity of the stress generated constant.

Moreover, as shown in (b) of FIG. 3, in a case that the width of the contact portion 101 and the width of the bent portions 102a to 102c are the same, parts of the area of the contact portion lot may deviate from the PCB land supplying an external power in an apparatus where the contact spring 100 is to be installed, and thus it may also be possible to design the width of the end of the contact portion 101 of the contact spring 100 smaller than the width of the part connecting to the bent portion 102a.

Here, the design in which the width of the end of the contact portion 101 is smaller than the width of the part connecting to the bent portion 102a does not affect the stress distributed over the bent portions 102a to 102c. Except this design is caused from a structural reason for making it easier to set the relative location of the PCB land and the contact in the apparatus where the contact spring is used.

Meanwhile, in the contact spring structure as shown in (a) and (b) of FIG. 3, if the contact portion 101 cannot be positioned at a center part between the bent portions 102a to 102c formed at the left and right, there arises a difference in the intensity of stress between the bent portion 102b at the left side and the bent portions 102a and 102c at the right side, thereby making the amount of compression of the left and right bent portions difference from each other. Due to this, the x-axis direction component of the sum of vectors for moving the contact is increased, and differences in stress distribution of the left and right bent portions may become dramatic.

Hence, even in a case that the contact is not positioned at the center between the left and right bent portions, in order to make uniform the stress distributed over the respective bent portions 102a to 102c, as shown in (c) of FIG. 3, the width of the left bent portion 102b and the width of the right bent portions 102a and 102c may differ from each other. Further, on the connecting surfaces connecting the bent portions 102a to 102c, the width of a middle part of the connecting surfaces may be smaller than the width of the part directly connecting to the bent portions 102a to 102c.

Moreover, as shown in (a) to (c) of FIG. 3, the surface connecting the contact portion 101 and the bent portion 102a may be sloped so as to prevent the bent portion 102a at the topmost side from contacting the PCB surface.

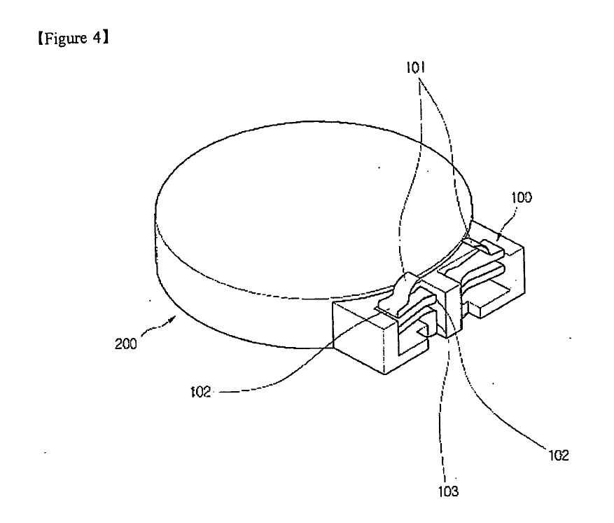

FIG. 4 is view showing a coin type vibration motor 200 for which a contact spring is used according to the present invention.

As shown in FIG. 4, in a contact spring 100 according to the present invention, the support portion 103 is supported, being coupled to the structure of the vibration motor 200, and the contact portion 101 comes in contact with a PCB land and can be used as a connection terminal for supplying a power source. Here, the contact spring 100 can generate vibration from the vibration motor 200 by receiving power from outside and delivering the received power to a vibrating portion that eccentrically rotates.

The contact spring 100 according to the present invention is applicable to various electrical equipment of such a structure receiving power from outside as well as a vibration motor, and can ensure a reliable power supply to such electrical equipment.

As seen from above, the contact spring according to the present invention have a high reliability because with energy dispersed and stored in two or more bent portions, the strain-energy density stored in the bent portions of the contact spring is reduced, and thus the magnitude of the stress distributed over the bent portions is reduced.

### INDUSTRIAL APPLICABILITY

According to the present invention, the strain-energy density stored in the bent portions of the contact spring is reduced, and thus the magnitude of the stress distributed over the bent portions is reduced, thereby providing a contact spring having a higher durability.

Furthermore, according to the present invention, the rotation phenomenon of the contact is reduced by adjusting the width of each bent portion and bent portion joint according to the relative location of the contact portion and the bent portion, and thus the amount of change in the relative location of the PCB land of the terminal and the contact can be reduced.

Furthermore, the contact spring is prevented from permanent deformation due to compression by uniformly dispersing the stress distributed over each bent portion by adjusting the width of the bent portion.

1. A contact spring, comprising:
a support portion connected to electrical equipment;
a contact portion electrically connected to an external power supply terminal;
at least two bent portions connected between the support portion and the contact portion and having a bent shape.

2. The contact spring of claim 1, wherein the bent portions are constructed in a semispherical shape or ‘C’-shape.

3. The contact spring of claim 1, wherein the width of the bent portions is different from each other according to their location,

4. The contact spring of claim 1, wherein the bent portions have the same width.

5. The contact spring of claim 1, wherein the width of the end of the contact portion is smaller than the width of the part connecting to the bent portions.

6. The contact spring of claim 1, wherein the contact portion is bent with a given curvature

7. The contact spring of claim 1, wherein the surface connecting the contact portion may be sloped so as to prevent the bent portion at the topmost side from contacting the PCB surface.

8. The contact spring of claim 1, wherein the strain energy generated in the entire bent portions is stored dispersed in the respective two or more bent portions.

9. The contact spring of claim 1, wherein the width of at least one of the connecting surfaces connecting the bent portions is at least partially smaller width than the width of the bent portions.

10. The contact spring of claim 1, wherein the electrical equipment is a vibration motor.

11. A vibration motor, comprising:
a contact spring including I
a support portion,
a contact portion electrically connected to an external power supply terminal,
at least two bent portions connected between the support portion and the contact portion and having a bent shape,
a vibrating portion eccentrically rotating by power supplied from outside through the support portion.

12. The vibration motor of claim 11, wherein the bent portions are constructed in a semispherical shape or ¹C-shape.

13. The vibration motor of claim 11, wherein the width of the bent portions is different from each other according to their location.

14. The vibration motor of claim 11, wherein the bent portions have the same width.

15. The vibration motor of claim 11, wherein the width of the end of the contact portion is smaller than the width of the part connecting to the bent portions.

16. The vibration motor of claim 11, wherein the contact portion is bent with a given curvature

17. The vibration motor of claim 11, wherein the surface connecting the contact portion may be sloped so as to prevent the bent portion at the topmost side from contacting the PCB surface.

18. The vibration motor of claim 11, wherein the strain energy generated in the entire bent portions is stored dispersed in the respective two or more bent portions.

19. The vibration motor of claim 11, wherein the width of at least one of the connecting surfaces connecting the bent portions is at least partially smaller width than the width of the bent portions.
